(19) United States
(12) Patent Application Publication
(10) Pub. No.: US 2005/0228593 A1
(43) Pub. Date: Oct. 13, 2005

(54) Method, system, and computer program for providing and evaluating medicine information

(76) Inventor: Reginald A. Jones, Fort Washington, MD (US)

Correspondence Address: VENABLE LLP, P.O. BOX 34385, WASHINGTON, DC, 20045-9998, US

(21) Appl. No.: 11/076,895

(22) Filed: Mar. 11, 2005

Related U.S. Application Data
(60) Provisional application No. 60/552,193, filed on Mar. 12, 2004.

(51) Int. Cl. G06F 17/60; G06F 19/00

(52) U.S. Cl. 702/19; 705/3

(57) ABSTRACT

A system, method, or computer program product may provide medical information to aid users in identifying new treatments for medical conditions, or in identifying adverse affects of drugs, or in locating clinical trials and medical conventions, or in providing prescription refill notification, or in providing information about conditions, drugs, and medical treatments. A user may be provided with an interface, with access to a server, through which queries of databases may be conducted. The databases may contain information about medical conditions, drugs, use of medicines, etc. The databases may be searched for a drug, a medical condition, or other keywords queried. By using this approach the user may locate many different drugs, adverse affects, clinical trials, medical conventions, or prescription services associated with a particular medical condition or treatment. The results of the queries may be reported to the user.

### CROSS-REFERENCE TO RELATED APPLICATIONS

This application claims the benefit of U.S. Provisional Application No. 60/552,193, filed Mar. 12, 2004, which is incorporated herein by reference in its entirety.

### BACKGROUND OF THE INVENTION

It is critical that information about various medical treatments, including the drugs involved in such treatments, be accessible to those involved with the application of treatments. In recent years, the complexity of treatments, often involving drugs used in combination, or drugs which may have adverse affects on patients when used in drugs for treating other conditions, has greatly increased the need for this information to be accessible.

Furthermore, the increasing number of treatments has made it more difficult for patients and doctors to determine which treatments are being tested. What drugs are used, which pharmaceutical companies manufacture a given drug, and scrutiny that the Federal Drug Administration (FDA) has given to those drugs are also difficult to determine.

In addition to the need for current information, patients and physicians alike may have difficulty in locating current sources of information, such as, e.g., but not limited to clinical trials which may be testing new drugs, and medical conventions where new treatments and drugs may be discussed. Furthermore, those involved in the application of drugs may benefit from the ability to report their own adverse affects to drugs, and to seek assistance if there are concerns about substance abuse.

Therefore, what is needed prior to the present invention, is a system to provide drug information associated with current medical treatments, including medical conventions, clinical trials, and other useful services for the collection and dissemination of drug information.

### BRIEF SUMMARY OF THE INVENTION

The invention may provide a method, system and computer program product by which medicine information may be provided and evaluated, for example, to identify new treatments for medical conditions, or to identify adverse affects of drugs, or to locate clinical trials and medical conventions, or to provide prescription refill notification, or to provide information about conditions, drugs, and medical treatments.

In an embodiment, the method may include providing a user with an interface, with access to a server, through which queries of databases may be conducted. The databases may contain information about medical conditions, drugs, use of medicines, etc. The databases may be searched for the drug, medical condition, or other keywords queried. By using this approach the user may locate many different drugs, adverse affects, clinical trials, medical conventions, or prescription services associated with a particular medical condition or treatment. The results of the queries may be reported to the user.

In an alternative embodiment, the user may provide personal information, such as, e.g., but not limited to, information about sex, age, gender, ethnicity, occupation, familial history, or adverse affects, etc., to the server using the interface. This personal information may be subsequently associated with one or more medical treatments or conditions. In circumstances where the user may provide permission, this personal information may be shared to varying degrees with, e.g., other users, physicians, pharmaceutical companies, or government agencies.

The present invention may use a computerized system for gathering, storing and processing information associated with medical conditions and treatments to create and update databases which may containing useful medical information. The medical information may be used, for example, to identify new uses or restrictions on the use of drugs, or to develop improved safety information that can accompany drugs, such as, e.g., but not limited to, warning labels detailing known or suspected adverse affects of using a drug in combination with other types of medicines.

According to embodiments of the present invention, the system may gather, store, provide, and evaluate information regarding medical conditions or treatments, such as, e.g., but not limited to patients being treated in clinical trials or information presented at medical conventions. The system may be accessible for access by users, including, but not limited to, any persons or entities having a need or desire for the information including, without limitation, consumers, physicians, manufacturers, research institutions, health care insurance providers, and regulatory agencies.

These and additional features and advantages of the present invention will become more apparent from the detailed description set forth below when taken in conjunction with the drawings in which like reference characters generally identify corresponding elements throughout.

### BRIEF DESCRIPTION OF THE DRAWINGS

The accompanying drawings, which are incorporated herein and form part of the specification, illustrate embodiments of the present invention and, together with the description, further serve to explain the principles of embodiments of the invention.

FIG. 1 is an exemplary embodiment of a Pharmaceutical Company (PC) accessing a National Medical Cabinet (NMC) System according to the present invention.

FIG. 2 is an exemplary embodiment of a Business Object Server of the NMC system verifying FDA drug approval of a drug according to the present invention.

FIG. 3 is an exemplary embodiment of a Billing System for the NMC system to bill the PC according to the present invention.

FIG. 4 is an exemplary embodiment of the NMC system allowing NMC users to locate a drug by a disorder or by a body system according to the present invention.

FIG. 5 is an exemplary embodiment of the NMC system reviewing a prescription and providing a refill notification according to the present invention.

FIG. 6 is an exemplary embodiment of the NMC system allowing the NMC users to report adverse affects of a prescription drug to the FDA according to the present invention.

FIG. 7 is an exemplary embodiment of the NMC system allowing the NMC users to contact a pharmacist with questions about a drug according to the present invention.

FIG. 8 is an exemplary embodiment of the NMC system allowing the NMC users to locate clinical trials of a drug according to the present invention.

FIG. 9 is an exemplary embodiment of the NMC system for issuing information on a prescription drug recall to NMC users according to the present invention.

FIG. 10 is an exemplary embodiment of the NMC system and the features available to the NMC users 1004 according to the present invention.

FIG. 11 is an exemplary system for implementing the NMC system according to the present invention.

FIG. 12 is an exemplary embodiment of the present invention illustrating an exemplary graphical user interface (GUI) screen showing an exemplary homepage including an exemplary national medicine cabinet (NMC) portal system method and computer program product according to an exemplary embodiment of the present invention.

FIG. 13 is an exemplary embodiment of the present invention illustrating an exemplary graphical user interface (GUI) screen showing an exemplary homepage including an exemplary Locate Drug by Condition screen.

FIG. 14 is an exemplary embodiment of the present invention illustrating an exemplary GUI showing an exemplary results page; and

FIGS. 15A and 15B is an exemplary embodiment of the present invention illustrating an exemplary GUI screen that may be used in an exemplary page of a Web site.

It should be understood that these figures depict embodiments of the invention. Variations of these embodiments will be apparent to persons skilled in the relevant art(s) based on the teachings contained herein. For example, the flow charts contained in these figures depict particular operational flows. However, the functions and steps contained in these flow charts can be performed in other sequences, as will be apparent to persons skilled in the relevant art(s) based on the teachings contained herein.

### DETAILED DESCRIPTION OF THE INVENTION

FIG. 1 illustrates an exemplary embodiment of a Pharmaceutical Company (PC) 102 accessing the National Medical Cabinet (NMC) System to list a pharmaceutical drug according to the present invention. The NMC System may provide a NMC Web site that may be used by the PC 102 to list medications produced by the PC 102. In addition to listing medications of the PC 102, the NMC Web site may provide information on each medication, including, for example, symptoms treated by the medication, side effects, clinical trials of the medication, etc., as will be described below in detail. The NMC Web site also may allow a user to gain information on medication provided by the PC 102. The users may include third parties, which similarly to the PC may access the NMC System. These third parties may include various groups, which may provide discounts for or assistance with drugs or may be interested in providing or receiving information about drugs. In embodiments, these third parties may include Medicare, Medicaid, insurance companies, government agencies, or private groups, either non-profit or for-profit, such as, but not limited to, the Association for the Advancement of Retired Persons (AARP).

To list information on the NMC Web site, the PC 102 may be required to submit an application on a new pharmaceutical drug. The term, drug and medication, as used herein include medicines, treatments, vitamins, and other remedies, which may be used alone or in combination with other drugs to treat or prevent one or more conditions, illnesses, diseases or ailments. One of ordinary skill in the relevant arts would appreciate the applicability of the term in the system of the present invention, based at least on the teachings provided herein. The PC 102 may access the NMC remotely via the internet, or other network, to submit the application. At the NMC Web site, the PC 102 may be prompted to enter their Pharmaceutical Reference Code (PRC) 104, or to register as a new PC 102, to gain access to the NMC system. The PRC code may be a number or code that uniquely identifies the PC 102, or may be a username and a password of the PC 102. If the PRC code entered by a PC 102 may be not verified, the PC 102 may contact a customer service representative of the NMC system directly for verification. If the PRC code may be verified, then the NMC Web site may display the name of the PC 102 and any pending pharmaceutical drug registrations forms of the PC 102, as is described below. On the display, the PC 102 may be given a Select Entry Option 106. The Select Entry Option 106 may prompt the PC 102 to select a single order or a batch order 108 to register one or more new pharmaceuticals. The Select Entry Option 106 also may allow the PC 102 to update a previously registered pharmaceutical.

If the PC 102 selects to register a single order, the NMC system may prompt the PC 102 to enter drug registration information 110, and then the PC 102 may confirm and submit the drug registration information 112 of the single order to the NMC system. Otherwise, the PC 102 may save an incomplete drug registration form to be submitted at a later time. The drug registration information 110 may identify the name of the drug, the disorders or symptoms the drug treats, any side affects of the drug, and any other information related to the drug, etc. If the PC 102 selects a batch order, the NMC system may prompt the PC 102 to Review the batch uploading instructions 114. The PC 102 then may enter drug Information into a spread sheet 116 and may upload a batch file 118 which may contain the drug registration information on the multiple pharmaceuticals. The NMC system may prompt the PC 102 to enter a payment method 120. The NMC system may confirm and may submit the drug registration information 112 of the batch order and may assign assign a registration code and a drug ID for each registered drug. If the PC 102 selects to update a previously registered pharmaceutical, then the NMC web site may allow the PC 102 to update any previously saved drug registration information and to confirm and submit the drug registration information.

FIG. 2 illustrates an exemplary embodiment of a Business Object Server 202 of the NMC system which may verify FDA drug approval of the PC 102 pharmaceutical in the drug registration information included in the single or batch order according to the present invention. The Business Object Server 202 may receive a drug registration notification 204 from the drug registration information submitted by the PC 102 to the NMC system 102. The Business Object Server 202 then may access unverified drug information 206 to access an unverified drug 208 to identify the pharmaceutical. With information on the unverified drug 208, the NMC system may contact a FDA system, such as, e.g., but not limited to a FDA database of approved pharmaceuticals, to verify FDA approval of the drug 210 and to update and store the findings in the NMC system 212. Based on the findings 212, the NMC system may determine if the drug may be FDA approved 214. If the drug is not approved, then the NMC system may send a notification to the PC 102 that the drug is not listed as FDA approved 216 and does not list the drug on the NMC Web site. If the drug may be approved, then the NMC system may assign a registration code and a drug ID for the drug. The Business Object Server 202 may send a notification to the PC 102 that the drug has been successfully verified and that the drug may be being actively listed in the NMC Web site 218. The notification may include the registration code and the drug ID of the drug. The NMC system then may bill PC 102 with an invoice or may process a credit card payment 220 from the PC 102 for listing the drug, as will be described in detail below.

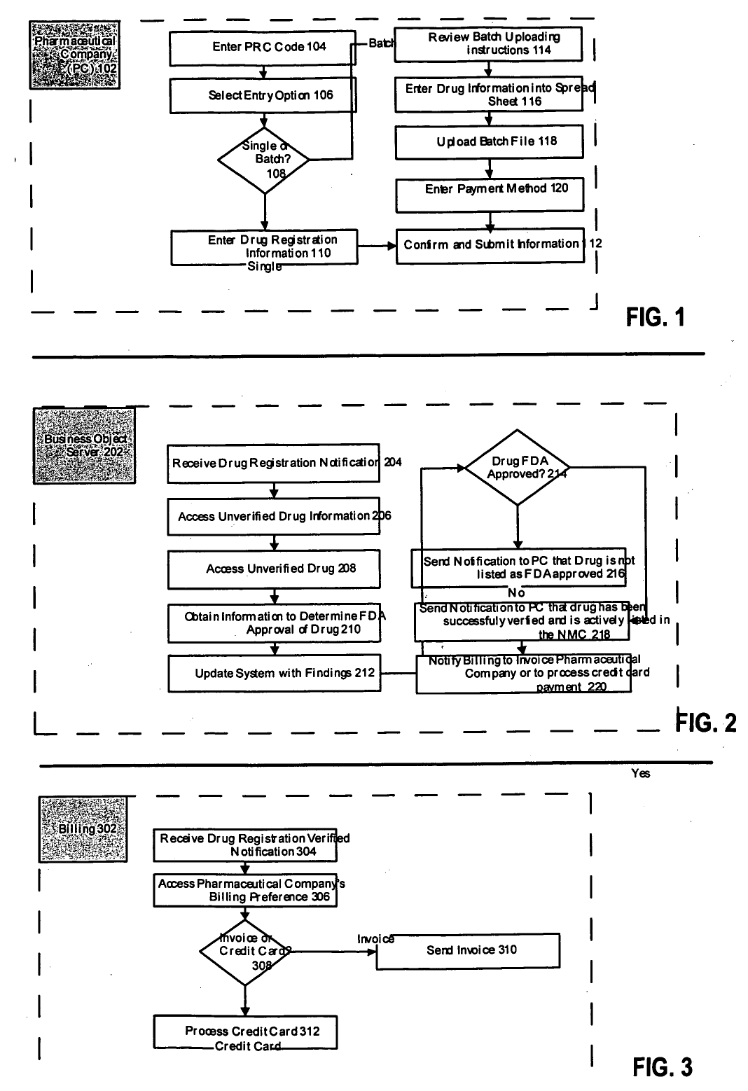

FIG. 3 illustrates an exemplary embodiment of a Billing Server 302 for the NMC System according to the present invention. After the NMC system verifies that the drug has received FDA approval, the Billing Server 302 may receive a drug registration verified notification 304. The Billing Server 302 then may access the billing preferences 306 of the PC 102 to determine if the PC 102 prefers payment by an invoice or by a credit card 308. If the PC 102 prefers to be sent an invoice, then the Billing Server 302 may send an invoice 310 to the PC 102. If the PC 102 prefers to pay using a credit card, then the Billing Server 302 may process a credit card. In an alternative embodiment, the Billing Server 302 may have a line of credit for a PC 102. The Billing Server 302 may provide a similar billing process when a customer fills a prescription using the NMC Web site, as will be described below.

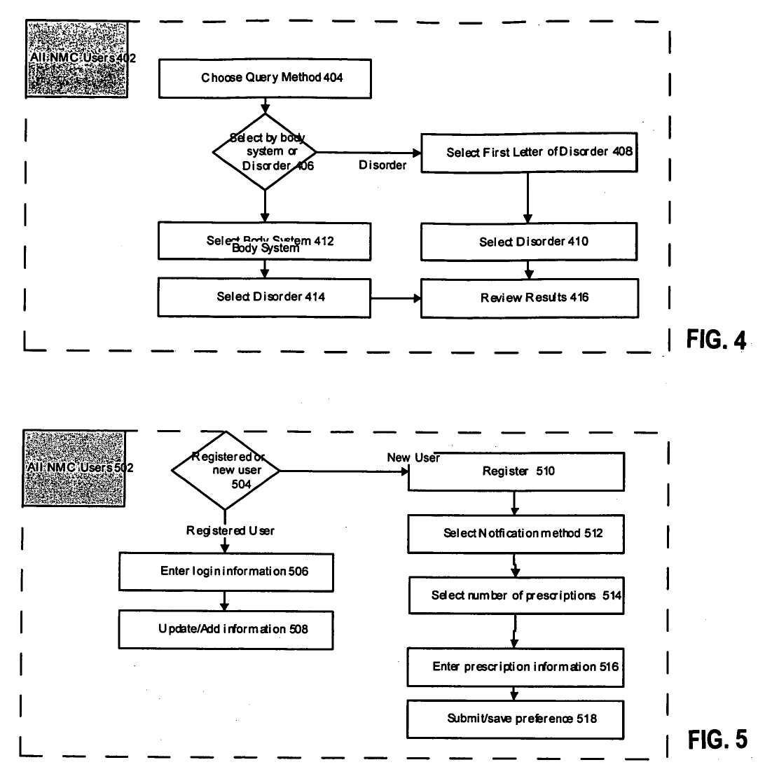

Once the NMC system lists a drug on the NMC Web site, the NMC Web site may allow NMC users to access information on all listed drugs. FIG. 4 illustrates an exemplary embodiment of the NMC system allowing NMC users 402 to locate a drug by a disorder or by a body system according to the present invention. When searching for information on drugs listed on the NMC Web site, the NMC Web site may allow the NMC users 402 to choose a query method 404 for searching for a drug. The query method may allow the user to query for a drug by a disorder or by a body system 406. In alternative embodiments, the user may also search for a drug using a condition or symptom query method. If the user selects to query by disorder, the user may be prompted to select the first letter of the disorder 408. From there the user may be allowed to select a disorder 410 from, for example, a list of disorders. In an alternative embodiment, the user may be prompted for search terms to identify a disorder. If the user selects to query by a body system, the user may be prompted, e.g., to select a body system 412 from a list, from a picture, or by entering a first letter or a search term for the body system. From the selection of the body system, the user may be prompted to select a disorder 414 from, for example, but not limited to, a list. After the disorder may be identified either by selecting the disorder/condition, directly or by identifying the body system, the user may review the results 416. In additional embodiments of the present invention, the user may search or modify search results by separating brand name from generic drugs, with additional information on trials, effectiveness, controls, costs, and/or other information optionally included.

FIG. 5 illustrates an exemplary embodiment of the NMC system for reviewing a prescription and for providing a refill notification of a prescription according to the present invention. NMC users 502 may access a NMC system Web site and may be prompted to register with the NMC system or to enter their registration code 504. The system may first determine whether the user is previously registered or new. If the user may be a registered user, the user may be prompted to enter login information 506 to log in to the NMC system. After logging in, the user may be allowed to update or add information to their account 508, such as, e.g., but not limited to, new prescription information, preferred pharmacy, physician, prescription delivery options, etc. Updating the account also may include revoking a previously submitted order, which could cause the Billing Server 302 to cancel an invoice or credit charge. If the user may be a new user, the NMC system may prompt the user to register 510. During registration 510, the user may be prompted to select a notification method 512, for use, e.g., on their prescription refill(s). This may include, e.g., but not limited to, email updates on when the prescription may be ready, or notification if their preferred pharmacist does not have the drug in stock and a list of alternate pharmacies carrying the drug. The NMC user 502 also may select their number of prescriptions 415 and may enter prescription information 516 on the name of the medication, their physician, preferred delivery method, payment method (used by the Billing Server 302), preferred pharmacist, etc. Once completed, the NMC user 502 may submit this registration information to the NMC system to save the users' preferences 518.

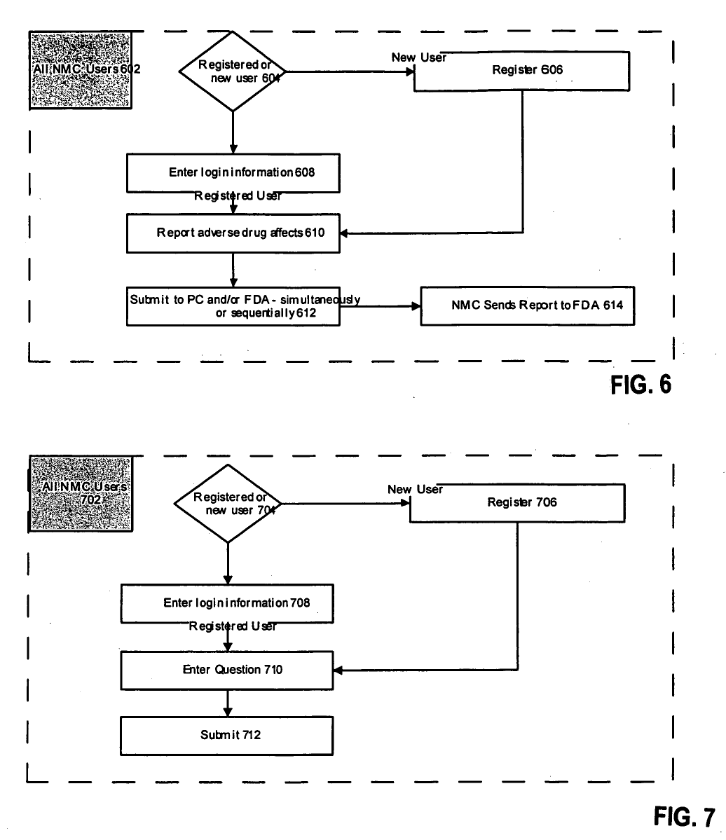

In addition to ordering and refilling prescriptions, the NMC system also may allow for patient feedback on any medications being used. FIG. 6 illustrates an exemplary embodiment of the NMC system allowing NMC users 602 to report adverse affects of a prescription drug to the FDA according to the present invention. The NMC users 602 access the NMC system at the Web site, and may be prompted to determine if the user may be a registered user or a new user 604. If the user may be a new user, the user may register with the NMC system 606. Otherwise, the registered user may enter their login information 608. After the user may be logged in to the NMC system, the user may report adverse drug affects 610 experienced and may submit any adverse affects 612 to the NMC system. The NMC Web site may include questions on the adverse affects of the drug to generate useful feedback to the FDA. Once the user has entered information on the adverse affects, the NMC system may generate and may send a report to the FDA 614 on the adverse affects experienced by the prescription drug users.

The NMC system also may allow the NMC users 702 to contact a pharmacist or a physician with any questions the users may have on a particular drug. FIG. 7 illustrates an exemplary embodiment of the NMC system allowing the NMC users 702 to contact a pharmacist according to the present invention. The NMC users 702 may access the NMC system at the Web site, and may be prompted to determine if the user may be a registered user or a new user 704. If the user may be a new user, the user may register with the NMC system 706. Otherwise, the registered user may enter their login information 708. After the user may be logged in to the NMC system, the user may enter a question 710 to ask a pharmacist, and may submit the question 712 to the NMC system. The question may then be presented to a pharmacist who may respond with an email, or who may contact the user directly with a response.

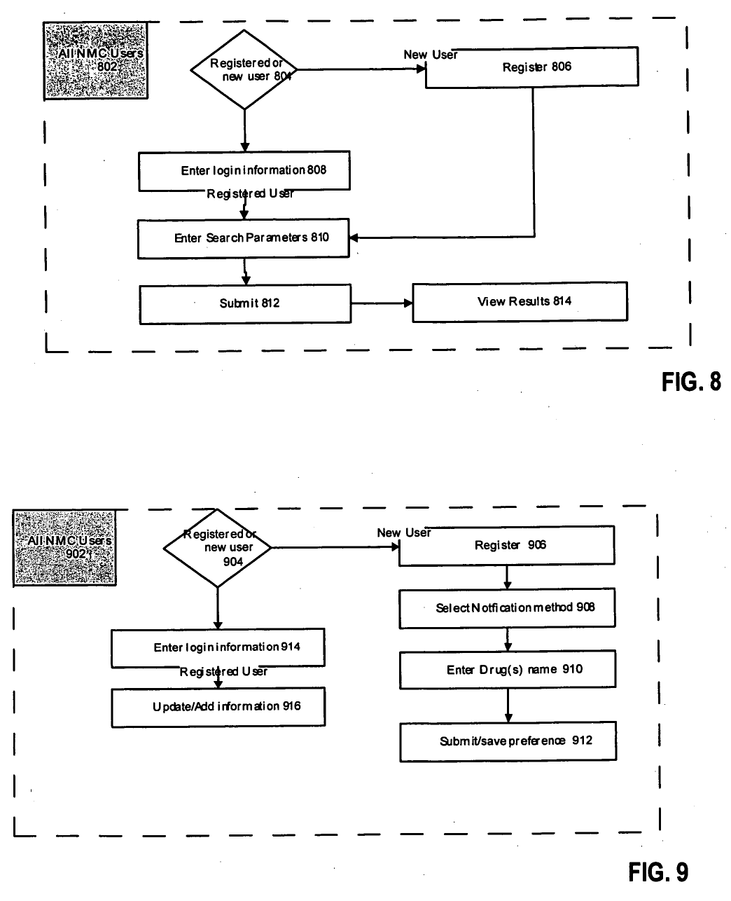

The NMC System may provide information on clinical trials for a particular drug. FIG. 8 illustrates an exemplary embodiment of the NMC system may allow the NMC users 702 to locate clinical trials of a drug according to the present invention. The NMC users 802 may access the NMC system at the Web site, and may be prompted to determine if the user may be a registered user or a new user 804. If the user may be a new user, the user may register with the NMC system 806. Otherwise, the registered user may enter their login information 808. After the user may be logged in to the NMC system, the user may enter search parameters 810 such as, e.g., but not limited to, on clinical trials for a particular drug, and submit 812 the search parameters to the NMC system. The NMC system may generate results based on the search parameters and transmits the results to the user so that the user may view the results 814. The results may include, e.g., studies on the medication, statistical information on the drug efficacy, or any other relevant information to a clinical trial.

The NMC system may provide a system for informing a NMC user 902 about any drug recalls issued by a PC 102 or the FDA. FIG. 9 illustrates an exemplary embodiment of the NMC system which may issue information on a prescription drug recall according to the present invention or may provide the recall information to other recall listings. The NMC users 902 may access the NMC system at the Web site, and may be prompted to determine if the user may be a registered user or a new user 904. The NMC system then may determine if the user may be a registered user or a new user 904. If the user may be a registered user, the user may be prompted to enter login information 914. After logging in, the user may be allowed to update or add information to their account about their preferences on receiving notifications about drug recalls. The preferences may include an email notification, a telephone notification, a mailed notification, etc. The notification may also be sent to the user's physician or pharmacist. If the user may be a new user, the NMC system may prompt the user to register 906. During registration, the user may be prompted to select their preferred notification method 908 on drug recall information and to enter any names of prescription drugs 910 they may be taking. After selecting the number of prescriptions, the user may enter any names of prescription drugs they may be taking and then the user may submit this information to the NMC system to save the users' preferences 912. The user may be notified according to their user preferences 912.

In one embodiment of recalling a drug, the FDA may send a notification message to the NMC system that a drug may be no longer approved. The NMC system could then remove the drug from the NMC Web site and forward a recall message to the PC 102 and the NMC users. The NMC system may also deactivate the drug from the billing server 302, and may stop any future renewal invoices or credit charges for the recalled drug.

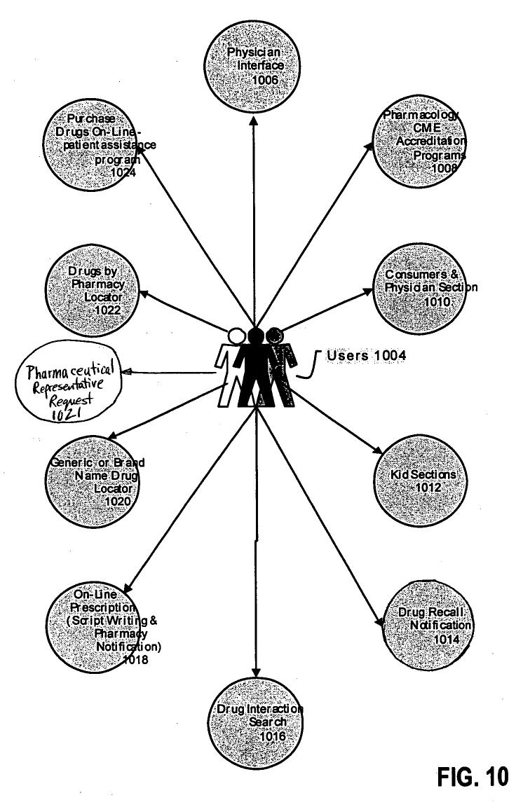

FIG. 10 may illustrate an exemplary embodiment of the NMC system and exemplary features available to the NMC users 1004 according to the present invention. The NMC Web site may provide numerous sources of information on prescription drugs to the NMC users 1004. The NMC system may provide a physician interface 1006 that may allow medical practitioners and pharmacists to find information on drugs provided by the PC 102 or by the FDA. Medical practitioners may have access through the NMC Web site on clinical trial information of the drug, as well as information on drug interactions and side affects. This feature also may allow medical practitioners to request that a drug manufacturer send a pharmaceutical representative to meet with them to provide additional information on a particular drug.

The NMC system may allow the pharmacist NMC users 1004 may access to Pharmacology continuing medical education (CME) accreditation programs. These CME accreditation programs allow pharmacists to take online CME courses to maintain their license.

The NMC system also may provide a consumers and physicians section 1010 which may include forums, private messaging, paging, or other functionality to assist with the public, private, and/or anonymous exchange of information. This section may allow for consumers and physicians to interact, such as, e.g., but not limited to, posting questions and responses, and to providing feedback on one or more drugs. This feedback may be positive or negative, and may be private or publicly shared based on the preferences of the PC providing the drug concerned, and such information may be provided anonymously, or may be provided by users who desire additional information be provided in response to their feedback. In embodiments of the present invention, the NMC System may provide feedback information to one or more users, PCs, or others. All or some of this information may be provided in webcasts which may be given by PCs or by third parties, including physicians, and which may be attended by some or all users of the NMC System.

Additionally, the NMC system may provide a kids section 1012. The kids section 1012 may include video that may be webcasted to a user's computer to educate children about the importance of pharmaceuticals. The kids section 1012 may teach children not to take drugs that may not be administrated by their guardians. Additionally, the kids section 1012 may include games to promote awareness and safety of pharmaceuticals.

Further features of the NMC system may include information about the prescription drugs. Importantly, the NMC system may provide a drug recall notification 1014 to the users who may be taking a drug that has been recalled. The drug recall notification 1014 may allow NMC users to register to receive notification from any drug recalls by the FDA or aPC 102.

The NMC system also may include a drug interaction search engine 1016 which may provide the NMC users 1004 with information on any potential drug interaction from their medications. The drug interaction search engine 1016 may provide a table or a search feature allowing users to select multiple drugs to determine if there may be any known negative drug interactions from taking any combination of the drugs together. For example, a user taking heart and blood pressure medication may run a search to determine if there may be any negative consequences or side effects when taking these two medications together.

The NMC system may provide for processing and filling online prescriptions. The NMC system may include a script or software for writing a new prescription and a pharmacy notification 1018 which may notify the NMC users' preferred pharmacy of the new prescription. Once a doctor prescribes a medication, this feature may allow the doctor to electronically write a prescription using the NMC system. The doctor may enter the prescription at a computer or a mobile device, and the prescription may be securely transmitted to the pharmacy selected by the doctor or the patient. At the pharmacy, the pharmacist may receive a notification from the NMC system about the prescription, and may fill the prescription. The electronic instructions may include other information, such as, e.g., but not limited to information on when a patient may pick up the prescription, or if the user could prefer to have home delivery.

The NMC system also may include a generic drug locator 1020 that may allow a user to locate or search for generic drugs. The user could enter the drug identified in their prescription, and the NMC system could search for any known generics. In an alternative embodiment, the NMC system could store information on the prescription drugs taken by the user, and the user could select or be automatically shown any suitable generic drugs.

The NMC system may provide the NMC users 1004 with features related to pharmacies. The NMC system may include a drugs by pharmacy locator 1022 that may allow a NMC user 1004 to find a pharmacy with a particular medication in stock, such as, e.g., but not limited to a medication prescribed by a physician or a suitable generic found by the generic drug locator 1020. Also, the pharmacy locator 1022 may determine if a user's preferred pharmacy has the prescribed medication, and if the drug may not be in stock, the pharmacy locator may suggest a list of one or more pharmacies carrying the medication. In additional embodiments of the present invention, the locator services of the present invention may be designed to address the needs of kids (that is, children or minors), and assist with the location of drugs given their special or particular needs.

The NMC system also may allow the NMC users 1004 to purchase drugs online 1024. After receiving a prescription and entering the prescription either by the user accessing the NMC Web site or by the physician entering the script writing and pharmacy notification 1018, a user may purchase a FDA approved drug over a secure internet, or other network connection. The user may select to have the drug prepared and made available at their preferred pharmacy, or the user may have the drug shipped or delivered to their home.

According to additional embodiments of the present invention, the above features may be alternatively described as follows:

Drug Interactions Table or Search Feature 1016 may allow users to select multiple drugs to determine if there may be any known negative drug interactions if the patient uses both drugs. For example, a user taking more than one medicine (such as heart and blood medications) may run a search to determine if there may be any negative consequences (side effects) when taking both medicines.

On-Line Prescription (Script Writing & Pharmacy Notification) feature 1018 may allow doctors to electronically prescribe medicine for patients by using the NMC. This information may then be securely transmitted to the pharmacy selected by the doctor where the pharmacist may be able to retrieve it.

Pharmacology CME Accreditation Programs feature 1008 may allow Pharmacist to take on-line CME courses to maintain their license.

Purchase Drug On-Line Capability 1024 may allow users with a prescription to securely purchase selected FDA approved drugs to be delivered to them.

Reporting of Adverse Affects feature 610 or 1016 may allow users to report negative side effects they experienced. The report may simultaneously be sent to the FDA and the drug manufacturer.

Recall Notification feature 1014 may allow users to register to receive notification of any FDA/manufacturer drug recalls.

Request a Pharmaceutical Representative feature 1021 (which may be part of physicians' interface 1006), or another component, may allow doctors/authorized healthcare professionals to request that the drug manufacturer may send a pharmaceutical representative to meet with them and provide more information on a specific drug.

Alternative/similar drugs search feature may be part of 1020 and may allow users to select a drug and identify alternate or similar drugs to the drug selected.

Generic Drug Locator feature 1020 may allow users to locate/search for generic brands only.

Drugs by Pharmacy Locator 1022 may allow users to locate pharmacies that stock specific generic drugs.

Search Drugs by Name may allow users to enter a specific drug name and receive information about the drug. Other methods of searching for drugs may be made available, such as, e.g., but not limited to, searches for illnesses or indications, or searches for drugs related to groups, such as, e.g., but not limited to, for Children's Drugs Locator may be provided to search for Drugs for children, an Geriatric Drugs Locator may be provided to search for drugs from that age group, another age related patient drugs locator may be provided, another category of drugs related to a category of people may be provided, for all FDA approved drugs, by conditions, by brand, by generic, etc.

Kids Sections 1012 have web-casting video to educate children about the importance on pharmaceuticals. This section may also teach children not to take drugs that may not be administered by their guardians. There may be included games to help promote the awareness and safety of pharmaceutical.

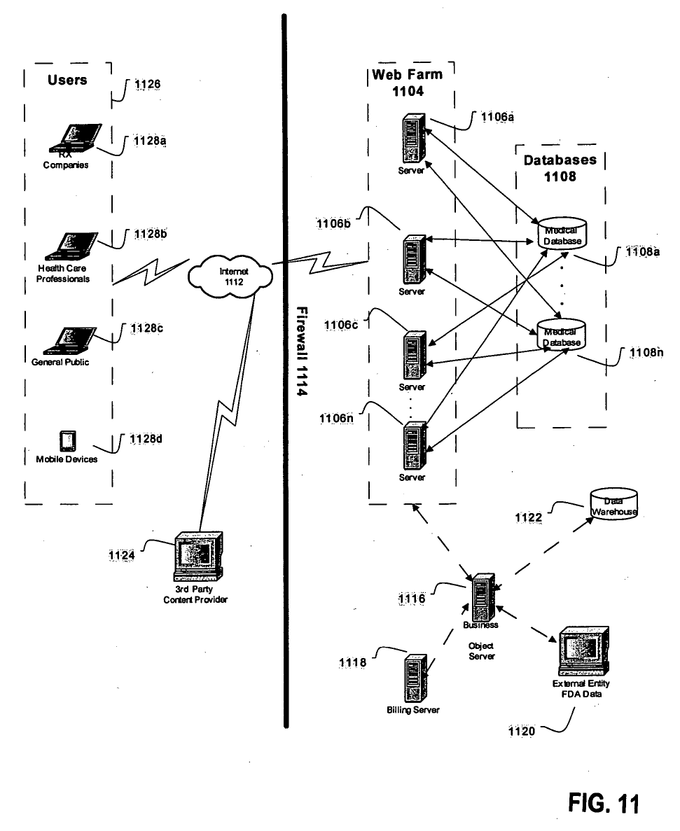

FIG. 11 illustrates an exemplary system for implementing the NMC system according to the present invention. The NMC system may allow users 1126 and third party content providers 1124 to interact with the NMC system via a data network, such as, e.g., but not limited to, the Internet, or other network. Included in the NMC system may be a Web Farm 1104 and a clustered database 1108. The Clustered Database 1108 may include multiple medical databases 1108a-1108n, collectively. The Clustered Database 1108 may include as many medical databases 1108a-n as may be necessary to store medical data and to effectively meet the needs of the NMC users. The Web Farm 1104 communicates data with the Clustered Database 1108 using a group of servers 1106a-1106n. The group of servers 1106a-1106n may also communicate with a Business Object Server 1116 and/or the Internet, or other network, 1112 through, e.g., a firewall 1114. The fire wall 1114 may be used to prevent unauthorized access of the Web Farm 1104 by an unknown user. In an alternate embodiment, the Web Farm 1104 may communicate with the Internet, or other network, 1112 without having the firewall 1114.

The Business Object Server 1116 may also communicate data with, e.g., but not limited to, a Data Warehouse 1122, a Billing Server 1118, and an External Entity with FDA Data 1120. The Business Object Server 1116 may interact with the Web Farm 1104 and the Clustered Database 1108 to process requests from users 1126. The users may include, e.g., but not limited to, pharmaceutical (Rx) companies 1128a, Health Care Professionals 1128, the General Public 1128c, or Mobile Devices 1128d used by any of these groups. Once the user 1126 is registered with the NMC system, e.g., but not limited to, the Web Farm 1104, the Clustered Database 1108, and/or third party providers 1124 may provide information to the users 1126 under the direction of the NMC system, as described in FIGS. 4-10.

When processing an order from a pharmaceutical (Rx) company 1128a to list a drug, the NMC system may use the Business Object Server 1116. The request for registration by the Rx company 1128a may be first processed by the NMC system, as described above in FIG. 1. Once the Rx company 1128a has submitted their request (FIG. 1), the Business Object Server 1116 may process the request and may verify with the FDA the status of the drug (FIG. 2). In verifying the FDA approval of the drug, the Business Object Server 1116 may first interact with the Data warehouse 1122 to determine if the Data warehouse 1122 may include any information on the FDA approval of the requested drug. If no information may be found, the Business Object Server 1116 may communicate with the External Entity with FDA data 1120 to verify FDA approval of the drug. The Business Object Server 1116 may receive results from the External Entity with FDA data 1120 and may update the Data Warehouse 1122 with the results. Once the request is verified, the Business Object Server 1116 may interact with the Billing Server 1118 to bill the PC 102 for listing the drug on the NMC Web site (FIG. 3). The Billing Server 1118 may create invoices for the Rx company 1128a requesting to have drugs listed, or may process credit transactions of the Rx company 1128a, as described in FIG. 3 above. If the External Entity with FDA data 1120 indicates that the requested drug may be not FDA approved, then the Business Object Server 1116 may transmit this information to the RX company 1128a and may instruct the NMC system not to list the drug on the NMC Web site. Likewise, when the health care professionals 1128b or general public 1128c use the NMC services to prescribe or order medication, the Business Object Server 1116 may verify the users and the Billing Server 1118 may create invoices for the users obtaining the listed drugs, or may process credit transactions of the users

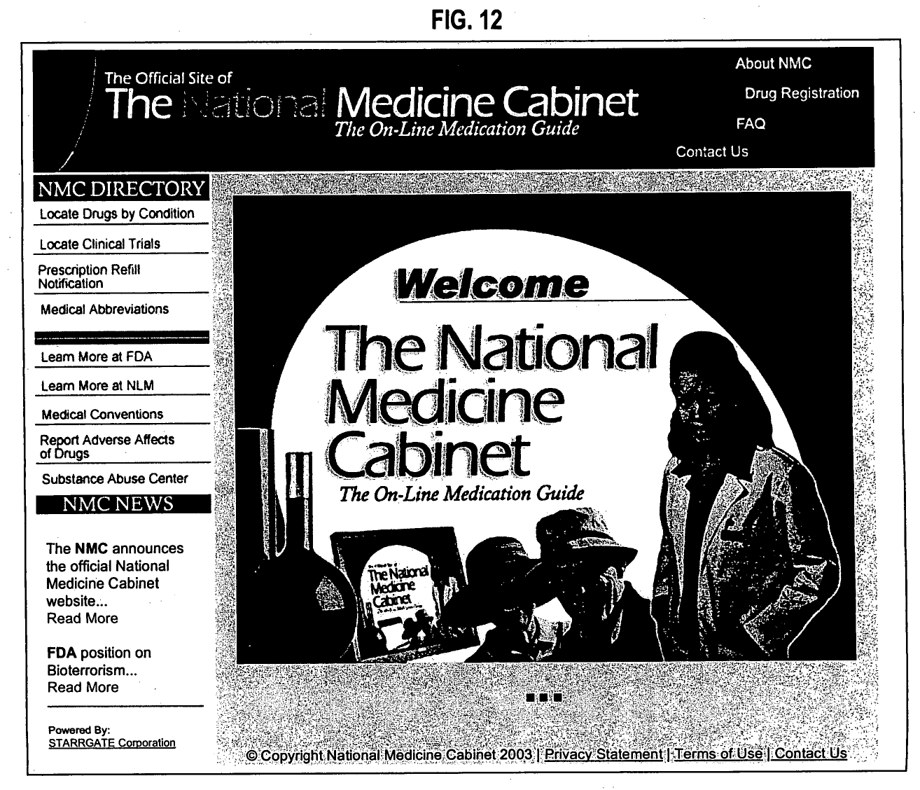

National Medical Cabinet (NMC) Homepage Exemplary Embodiment Description (see FIG. 12)

FIG. 12 depicts an exemplary embodiment of the present invention illustrating an exemplary graphical user interface (GUI) screen showing an exemplary homepage including an exemplary national medicine cabinet (NMC) portal system method and computer program product according to an exemplary embodiment of the present invention. In an exemplary embodiment, the homepage may include such information as, e.g., but not limited to, information that may be helpful to, e.g., but not limited to, both consumers and healthcare professionals. In an exemplary embodiment, the homepage may provide access to the following exemplary features, functionality and/or information including any combination of, e.g.,:
1. About NMC. The about NMC section may contain, in an exemplary embodiment, an overview of the NMC and/or, e.g, functionalities and features of the NMC portal.
2. Drug Registration. The drug registration section, in an exemplary embodiment, may allow one or more pharmaceutical companies, e.g., to register, e.g., their drugs into an NMC database. The registration process may include various ease of use features including, e.g., but not limited to, any combinations of, e.g., validation, queuing, approval, modification, revisions, change control and/or staging may process.
3. FAQ. An exemplary embodiment may include a frequently asked questions (FAQ) section that may include, e.g., but not limited, information about the NMC portal.
4. Contact Us. The contact us section, in an exemplary embodiment, may allow, e.g., but not limited to, consumers and/or healthcare professionals, e.g., to contact, e.g., but not limited to, the NMC directly, for any of, e.g., but no t limited to, questions, suggestions, and/or comments, etc., that the users may have, e.g., as relating to, e.g., but not limited to, the NMC.
5. Locate Drugs by Condition. The locate drugs by condition section, in an exemplary embodiment, may allow, e.g., but not limited to, consumers and/or healthcare professionals, a user friendly interface to, e.g., but not limited to, locate drugs by condition, in an exemplary embodiment. The conditions, according to an exemplary embodiment of the present invention, may be determined by, e.g., but not limited to, 1.) may include selecting a condition's body system and then may allow selecting a related condition; and/or, 2.) may include selecting a first letter of a condition and then may allow selecting from, e.g., a populated list of exemplary conditions for which the user may be seeking, etc.
6. Locate Clinical Trials. The locate clinical trials section, according to an exemplary embodiment, may allow users to, e.g., but not limited to, locate clinical trials information from the National Institutes of Health (NIH).
7. Prescription Refill Notification. The prescription refill notification section, according to an exemplary embodiment, may allow, e.g., any of, consumers and/or healthcare professionals, to have, e.g., but not limited to, automated notifications sent to patients for, e.g., but not limited to, prescription compliance.
8. Medical Abbreviations. The medical abbreviations section, according to an exemplary embodiment, may include, e.g., but not be limited to, displaying a list of, e.g., but not limited to, Medical Abbreviations and/or symbols.
9. Learn More at FDA. The learn more at FDA section, according to an exemplary embodiment, may include, e.g., but not be limited to, allowing users to view, e.g., but not limited to, an index for, e.g, but not limited to, sections of, e.g, but not limited to, the FDA web site, etc.
10. Learn More at NLM (National Library of Medicine). The learn more at NLM section, according to an exemplary embodiment, may include, e.g., but not be limited to, allowing users to, e.g., but not limited to, viewing an index for sections of the NLM web site, for example.
11. Medical Conventions. The medical conventions section, according to an exemplary embodiment, may include, e.g., but not be limited to, displaying information about, e.g., medical conventions.
12. Report Adverse Affects of Drugs. The report adverse affects section, according to an exemplary embodiment, may include, e.g., but not be limited to, allowing users to report adverse affects simultaneously to, e.g, but not limited to, both FDA and the reported drug manufacturer.
13. Substance Abuse Center. The substance abuse center section, according to an exemplary embodiment, may include, e.g., but not be limited to, may display access to a center that may identify organizations that may provide assistance for, e.g., substance abusers.
14. NMC News. The NMC news section, according to an exemplary embodiment, may include, e.g., but not be limited to, may display pharmaceutical articles and other documentation.
15. Privacy Statement. The privacy statement section, according to an exemplary embodiment, may include, e.g., but not be limited to, may display privacy statement content, for example.
16. Terms of Use. The terms of use section, according to an exemplary embodiment, may include, e.g., but not be limited to, may display terms of use for all users of the site, for example.

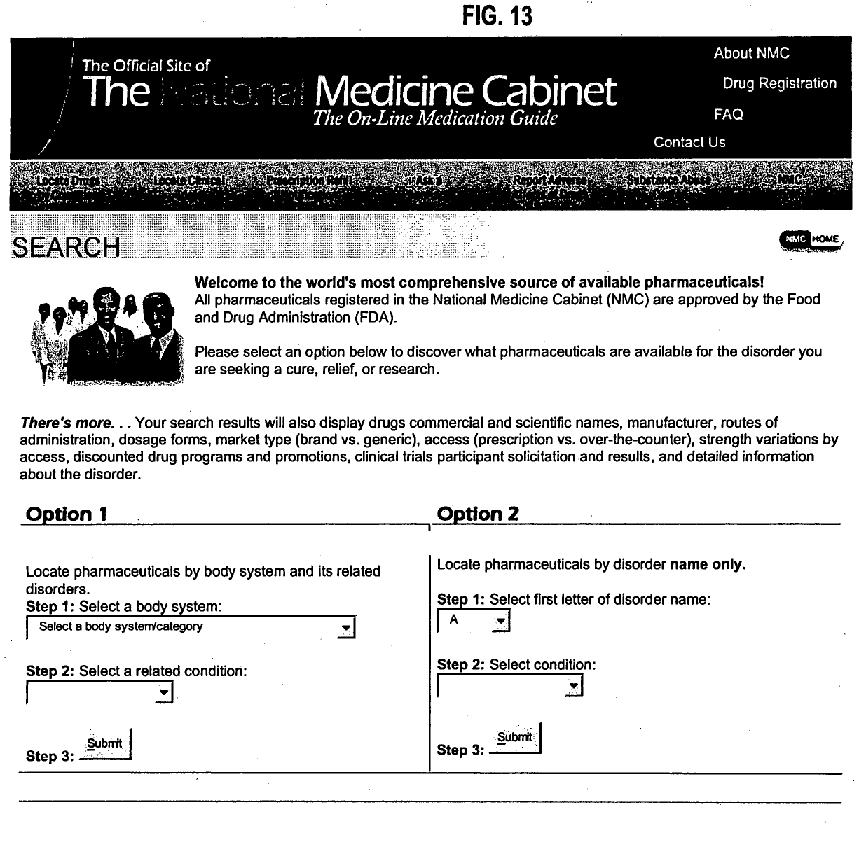

NMC Locate Drug by Condition (see FIG. 13)

FIG. 13 depicts an exemplary embodiment of the present invention illustrating an exemplary graphical user interface (GUI) screen showing an exemplary homepage including an exemplary Locate Drug by Condition screen. In an exemplary embodiment, the locate drug by condition feature may include, e.g, but not limited to, allowing users to search for FDA approved drugs by, e.g., but not limited to, body system and/or their related conditions. The search feature, in an exemplary embodiment, may be labeled as Option 1. Option 1, in an exemplary embodiment, may require, e.g., the users to, e.g., identify a body system from, e.g, but not limited to, a pre-populated list (Step 1 of Option 1). In an exemplary embodiment, after the user has successfully identified a body system, the user may be prompted to select a related medical condition from, e.g., but not limited to, a second drop-down list (Step 2 of Option 1). The drop-down list in an exemplary embodiment may be populated based on, e.g., but not limited to, the body system selected. For example, if the user selects “Respiratory” for a body system, then the second drop-down may, in an exemplary embodiment only populate with medical conditions related to the, e.g., but not limited to, “Respiratory” system. In an exemplary embodiment, once Step 1 & Step 2 for Search Option 1 is completed, the user may submit the search request; which may be Step 3 of Option 1, as illustrated in the exemplary GUI screen.

Option 2, in an exemplary embodiment, may require the users to identify the first letter of the medical condition's name for which, e.g., they may be seeking a drug for (Step 1 for Option 2). In an exemplary embodiment, after the user has successfully selected the appropriate alphabet, the user may be prompted to select, e.g., but not limited to, the medical condition from a second drop-down list (Step 2 of Option 2). The drop-down list may be populated based on the alphabet selected in Step 1 of Option 2, in an exemplary embodiment. For example, if the users select the letter “A”, then the second drop-down may in an exemplary embodiment only populate with medical conditions starting with the letter “A”, for example. Once Step 1 & Step 2 for Search Option 2 have been completed, in an exemplary embodiment, the user may submit the search request; which may be Step 3 of Option 2, as illustrated in the exemplary embodiment.

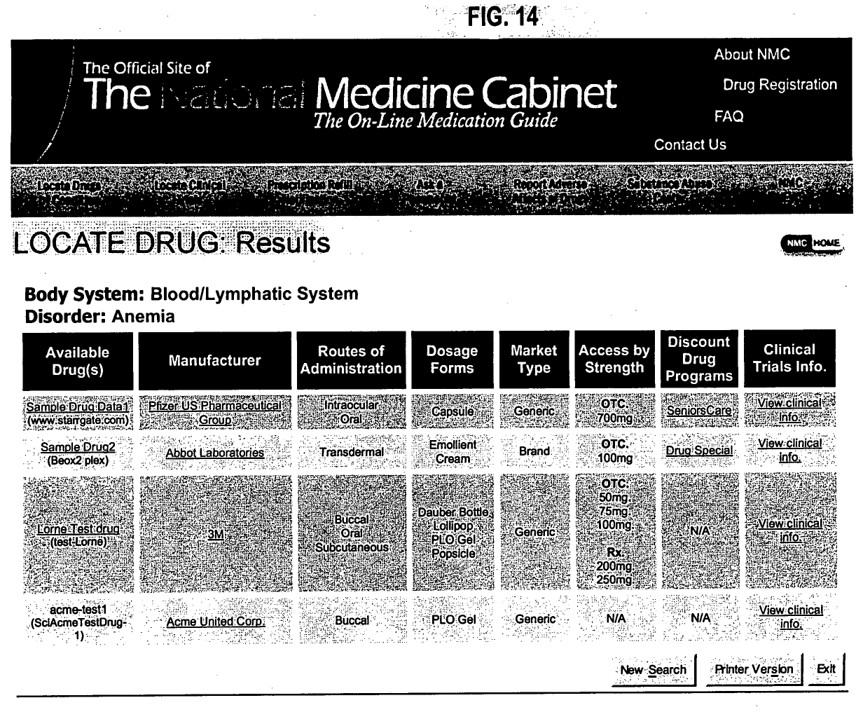

NMC Locate Drug by Condition Results Page (See FIG. 14)

FIG. 14 depicts an exemplary embodiment of the present invention illustrating an exemplary GUI showing an exemplary results page that may, in an exemplary embodiment, display, e.g., but not limited to, the following exemplary information:
a body system—a display may be provided in an exemplary embodiment, of a body system that may be applicable to a condition
a condition—an exemplary embodiment of the results page may state “Disorder,” in one exemplary embodiment, or, in another exemplary embodiment, may alternatively state “Condition” for a similar field. The condition that may have been selected, according to an exemplary embodiment, may be displayed. The condition may, in an exemplary embodiment, have a tag line next to the condition, that may let a user know that if the user clicks or selects a tag line, that the user may be able to find, e.g., but not limited to, additional, e.g., more detailed information about, e.g., the condition from other data sources, such as, e.g., but not limited to, information from National Institutes of Health (NIH), and/or, National Library of Medicine (NLM). The tag line may, in an exemplary embodiment, link the user to, e.g., but not limited to, the NLM web site where exemplary detailed information about, e.g., but not limited to, the condition, where other information may be located; and/or additional information such as, e.g., but not limited to, general information, definitions, and/or clinical trial information.
available drug(s)—an exemplary embodiment of the present invention may include a system that may list in, e.g., but not limited to, a matrix format, information including, e.g., but not limited to, drugs that may meet the search criteria that may have been input by the users. Each drug listed may include, e.g., but not limited to, any one or more of the following, a brand name of the drug, a scientific name, a manufacturer, routes of administration, dosage forms, available market types, access by strength, patient assistance programs, and/or clinical trial information, etc.
Brand Name—may include, e.g., but not limited to, the commercial name for drugs.
Scientific Name—may include, e.g., but not limited to, the drug formulary names.
Manufacturer—may include, e.g., but not limited to, the company that produces the drug.
Routes of Administration—may include, e.g., but not limited to, the way(s) the drug can be administered
Dosage Forms—may include, e.g., but not limited to, the various forms the drug is available (capsule, PLO gel, etc.)
Market Type—may include, e.g., but not limited to, whether brand or generic
Access by Strength—may include, e.g., but not limited to, the different dosage strength the drug may be available
Patient Assistance Programs—may include, e.g., but not limited to, any special promotion that the drug companies may have to make the drugs assessable
Clinical Trials Info.—may include, e.g., but not limited to, the recruitment for participation or links to results and populations factors

In another exemplary embodiment, the matrix may include, e.g., but not limited to, a column and active key to allow physicians to prescribe the drug right from the results page, etc. This feature may include, e.g., but not limited to, sending the prescription directly to the pharmacy, and/or sending a confirmation to a prescribing physician, and/or prescribed patient, etc.

In another exemplary embodiment, the system and method may allow users to display results by, e.g., but not limited to, Manufacturer, Routes of Administration, Dosage Forms, Market Type, Access by strength, Drug strengths, and/or any combination of these, etc. This feature may include, e.g., but not limited to, a Key Word Search, Secondary Search, Search with Search Capabilities, and/or any combination, etc.

In one exemplary embodiment, the present invention may receive a request from a physician user. In an exemplary embodiment, the request may include a request that at a pharmaceutical representative call or visit the physician.

In another exemplary embodiment, the system may receive a search for drugs. The search may include a search for all FDA approved drugs. The search may include all FDA aproved drugs related to a given condition. In one exemplary embodiment, the search may provide brand drugs, generic drugs, or both to the user.

In one exemplary embodiment, the search may receive requests for patient assistance. The requests could provide information in a patient assistance databank. Information may include, e.g., but not limited to, any of, private information, privacy information, government information, pharmaceutical company information, or consumer group information.

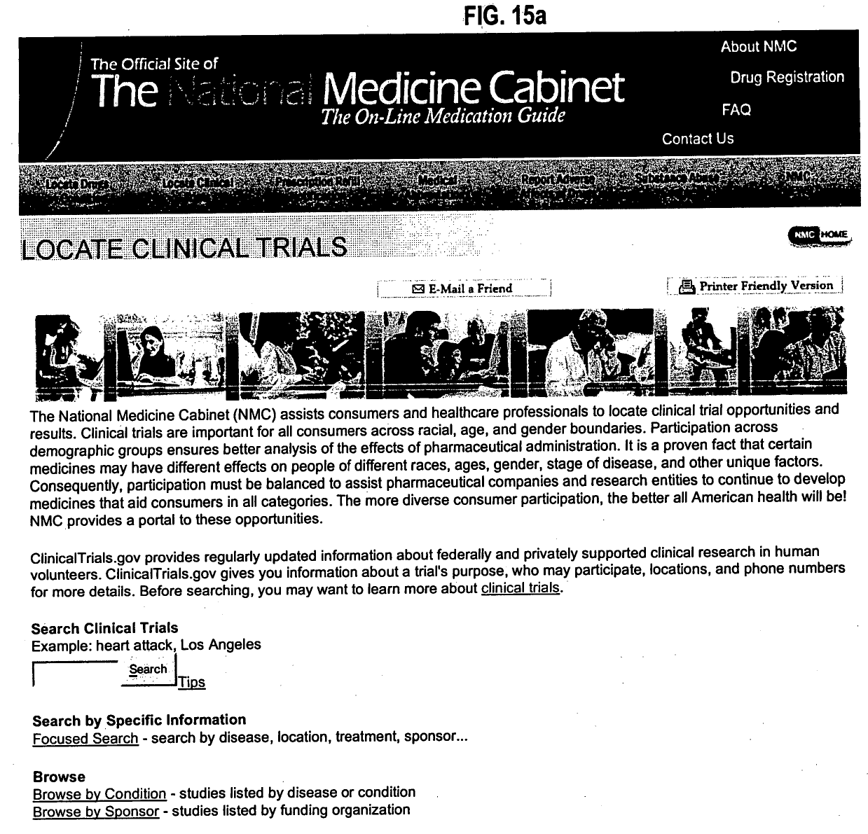

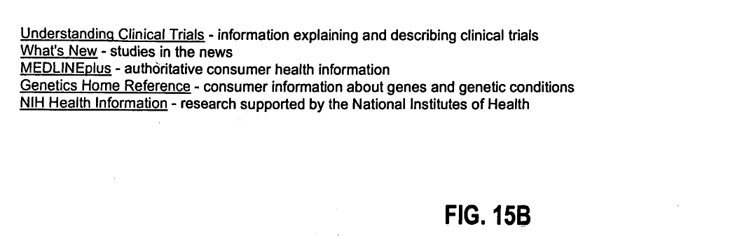

NMC Locate Clinical Trials (See FIGS. 15A and 15B)

FIGS. 15A and 15B collectively depict an exemplary embodiment of the present invention illustrating an exemplary GUI screen that may be used in an exemplary page of a Web site. In the exemplary embodiment, the page may generally give an explanation of an importance of clinical trial participation. Various useful exemplary features are shown in the exemplary GUI in FIGS. 15A and 15B. The exemplary page of the exemplary GUI shown in FIG. 15 may be integrated with a NIH Clinical Trial Web page.

NMC Prescription Refill Notification

In another exemplary embodiment of the present invention, the exemplary NMC portal may include, e.g., but not limited to, a Prescription Refill Notification service. In an exemplary embodiment, the exemplary NMC portal may allow, e.g., but is not limited to, patients and/or physicians to register, e.g., but not limited to, to have prescription refill notifications sent to, e.g., but not limited to, the patient, or other recipient. In an exemplary embodiment, the system may also, e.g., allow sending, e.g., but not limited to, a dosage intake reminder. These exemplary notifications may be, e.g., registered to, received, and/or transmitted, in an exemplary embodiment, in any or all of the following exemplary segways, including, e.g., but not limited to, telephony, electronic devices, wireless, hand-held, portable, mobile, technologies, computer, communication devices, computing devices, and/or personal digital assistants (PDAs), etc. Notifications, in an exemplary embodiment, may be sent to, e.g., but not limited to, one recipient via, e.g., but not limited to, multiple notification options for, e.g., but not limited to, a single prescription.

In an exemplary embodiment, once a system notifies the patient, the patient may have an ability to, e.g., but not limited to, send a refill request, e.g., but not limited to, directly to, e.g., but not limited to, the pharmacy that may be of their choice, by whichever media notifies the patients; provided if the device may allow it.

NMC Drug Hazards

In another exemplary embodiment of the present invention, the exemplary NMC portal may include, e.g., but not limited to, a Drug Hazards service that may, in an exemplary embodiment, allow, e.g., but not limited to, healthcare professionals and/or consumers the ability to, e.g., but not limited to, search drugs that may be, e.g., but not limited to, absolutely prohibited for taking simultaneously, for example for reasons such as, e.g., bad interactions, etc.

NMC Adverse Affects of Drugs

In another exemplary embodiment of the present invention, the exemplary NMC portal may include, e.g., but not limited to, a module that may allow a user to report, e.g., but not limited to, an adverse affect of a drug. When the report may be submitted, the report may be sent to, e.g., but not limited to, the FDA and/or the manufacturer, and may be sent to both, simultaneously, in one exemplary embodiment.

NMC Prescription Refill Notification—The Prescription Refill Notification service of the NMC may allow patients and physicians to register to have prescription refill notifications sent to the patient. The system also has the ability to send dosage intake reminders. These notifications can be registered to, received, and transmitted in the following segways: Telephony, Electronic Devices, Wireless, Hand-Held Technologies, Computer, as one of ordinary skill in the relevant arts could appreciated based at least on the teachings provided herein. Notifications can be sent to one recipient via multiple notification options for a single prescription.

Once the system notifies the patient, the patient may have the ability to send a refill request directly to the pharmacy of their choice by whichever media notifies the patients; provided if the device may allow it.

NMC Drug Hazards—The Drug Hazards service of the NMC may allow healthcare professionals and consumers the ability to search what drugs may be absolutely prohibited for taking simultaneously.

NMC Adverse Affects of Drugs—This module of the NMC may allow user to report an adverse affect of a drug. When the report may be submitted, the report may be sent to both the FDA and the manufacturer simultaneously.

### Alternative Embodiments

The following outlined sections and items provide alternative embodiments to the may process of the NMC System described herein.

1.0 Registering a Drug(s)

1.1 Customer may access the NMC system via the internet, or other network, using the NMC URL.

1.2 The Customer may enter their PRC code and Username, then select Proceed.

1.3 After the customer has logged in, NMC system may validate that the PRC code entered may be valid.

Might want to require a username (email address) to ensure no made a typing error or display an acknowledgement window with the company name that matches the PRC code.

1.3.1 If the PRC code is valid, continue to step 1.4.

1.3.2 If the PRC code may be not valid, the following action should or may occur:
A. NMC system should or may display window requesting the customer to enter their email address.
B. NMC system should or may validate that the email address match an existing domain name.
C. If email address does match, send email to POC email address which may contain the PRC code. NMC should or may display a message to customer that email with PRC code was sent to the registered POC mailbox (go to step 3.4).
D. If email address does not match, the following actions should or may occur:
i. NMC should or may display a message to the customer to contact Customer Support.
ii. NMC should or may send a notification to Customer Support.
iii. Customer Support should or may resolve and email PRC to customer.

1.4 The NMC system display a screen with the following:
Name of Company that matches the PRC Code entered
The following options:
Register a new Pharmaceutical
Register 10 or more new Pharmaceuticals
Update a Registered Pharmaceutical
Queue of any pending orders for this customer.

1.5 The NMC system should or may display the Drug registration form to be completed by the customer.

1.5.1 Customer should or may have the ability to save partially completed Drug registration forms to be completed at a later time.

1.5.2 During next login session to NMC, the system should or may display a screen that list all drug registration forms for that usemame (email) and PRC code that may be still in pending state.

1.6 NMC system should or may valid that all required fields may be completed on the registration form.

1.6.1 If invalid, NMC should or may provide customer with error message informing them which fields may be missing.

1.7 After the customer completes and may submit a valid drug registration form the system should or may assign a Registration code and Drug ID (for each drug).

1.8 NMC system should or may then send confirmation emails to the Customer and Customer Services.

1.9 NMC system should or may then verify that the FDA has approved the requested registered drug(s).

1.9.1 If approved by FDA, display registration details for Customer Acceptance and proceed to step 3.10.

1.9.2 If not approved by FDA, NMC system needs to send a notification to Customer Services and display an error message informing Customer that Customer Services may contact via email and Customer Services contact number.

1.9.2.1 Customer services may research and send email to Customer with corrective actions (emailed may be stored in NMC database).

1.9.2.2 The Customer may then make correction in NMC.

1.10 NMC system may Activate the Drug (enter date/time drug activated) and send a notification to Customer Services to test the drug on NMC web page.

1.11 Customer Services may access NMC to test that the drug may be activated in the appropriate categories and web pages.

1.11.1 If the test pass, indicated pass in NMC and proceed to step 3.12.

1.11.2 If the test failed, may contact system administrator to correct and retest.

1.12 After Customer Services has indicated that the test has passed, the NMC system do the following:
send a electronic trigger to the Billing system
Place a notification in the Billing Queue
Send email to the Customer, stating Drug has been tested and activated.

FDA Drug Deactivation Process

1.0 Federal Drug Administration (FDA) may send an email notification to the Drug Analyst that the drug that may be no longer approved by the agency.

2.0 The Drug Analyst may perform the following after receiving the email notification from FDA:

2.1 Send email notice to company that registered the drug, informing them that the FDA has removed the drug from drug approval list.

2.2 Access deactivation page in NMC system to deactivate the drug. The NMC system may allow for a deactivation reason.

3.0 The NMC system may then remove the drug from all the system web pages and submit a deactivation trigger to the Billing System.

4.0 The Billing System may deactivate the drug, which may stop any future renewal invoices to be generated for that drug.

Customer Initiated Deactivation

1.0 Customer may send a deactivation email to Customer Services.

2.0 Customer Services may access NMC search for the existing drug, then change the order status to deactivate and select the deactivation reason.

3.0 The NMC system may then remove the drug from all the system web pages and submit a deactivation trigger to the Billing System.

4.0 The Billing System may deactivate the drug, which may stop any future renewal invoices to be generated for that drug.

NMC System Initiated Deactivation

1.0 NMC System User may be able to initiate a deactivation of a pending or completed order via either the NMC or Billing System by searching for the existing drug record, then changing the order status to deactivate and selecting a deactivation reason.

2.0 The system in which the deactivation was initiated may then remove the drug and submit a deactivation trigger to the other System.

Save Process

1.0 Once a customer order status has been given a deactivation date a notification should or may be sent the Save Queue.

2.0 The NMC System User should or may be able to reactivate the order.

Customer Billing Process

1.0 The billing process should or may be able to be trigger manually or electronically.

Manually

1.1 The Billing system may provide a screen that may display all billing notifications.

1.2 The Billing system may allow the user to display the billing details and submit or confirm to generate a customer invoice.

Electronically

1.3 The Billing system may be able to receive a Billing activation date from NMC system.

2.0 The Billing system may do the following after receiving a Billing trigger either manually or electronically:
Set the drug registration anniversary date for each drug registered as the same as the NMC activation date.
Place the drug registration request into the next billing cycle.
There may be two billing cycles each month;
1st-15th
16th-31st

3.0 The Billing system may produce two types of invoices at the end of the billing cycle:

3.1 Electronic invoice to be emailed to the Billing Contact mailbox via the Billing System.

3.2 Paper Invoice to be mailed to the Billing Contact address.

4.0 The Billing system may then place a customer invoice notification in the Outstanding Accounts Receivable queue.

5.0 The customer invoice notification may remain in this queue until the invoice is paid.

Delinquent Billing Payment Process

6.0 If the customer invoice is not paid within 60 days of the activation date, the system may send a non-payment letter to the customer via email and mail.

6.1 The Billing system may update the customer invoice notification in the Outstanding Accounts Receivable queue to display that the invoice is over 60 days due.

7.0 If the customer invoice is not paid within 90 days of the activation date, the system may send a non-payment letter to the customer via email and mail.

7.1 The Billing system may update the customer invoice notification in the Outstanding Accounts Receivable queue to display that the invoice is over 90 days due.

8.0 If the customer invoice is not paid within 120 days of the activation date, the system may send a non-payment letter that also may contain deactivation date to the customer via email and mail.

8.1 The Billing system may update the customer invoice notification in the Outstanding Accounts Receivable queue to display that the invoice is over 120 days due and deactivation date.

9.0 The Billing system may allow customer services to remove or adjust the deactivation date.

10.0 On the date of the deactivation date, the Billing System may verify that the customer invoice status is still “past due/deactivate”.

11.0 On the date of deactivation, if the customer account status is not “past due/deactivate” the Billing System should or may not submit a deactivation request to the NMC system.

12.0 On the date of deactivation, if the customer account status is still “past due/deactivate” then the Billing system may submit a deactivate trigger to NMC, change the status of the account to “deactivated”, and email a deactivation letter to the Billing and Company Point-of-Contacts.

13.0 The NMC system may deactivate drug(s) from the web pages, after receiving the deactivation trigger from the Billing system and then send a customer deactivation notification to the Save Team.

Customer Renewal Process

14.0 The Billing system should or may generate a customer renewal invoice for all drugs that have not be deactivated or cancelled 60 days prior to the drug anniversary date.

15.0 The Billing system may generate an electronic and paper invoice. The electronic invoice should or may be emailed to the Billing POC mailbox.

General System Functions

1.0 The NMC and Billing systems may require internal NMC System users to login into by requiring a username and password.

2.0 After a NMC System user successfully logs into the system, the system should or may associate their login ID to all actions performed within the system.

3.0 The systems may have defined roles with separate permissions and rights.

4.0 Each user/group should or may have its own working queue in which notifications may be sent for their attention.

5.0 NMC System Users should or may have the ability to search for orders.

6.0 NMC System and Customers should or may have the ability to modify a completed order. Must indicate reason for change.

7.0 NMC System and Customers should or may have the ability to view order history by either PRC code or email address.

8.0 The NMC system needs to provide the capability to enter multiple drugs on one order.

9.0 The NMC system needs to provide the capability to accept electronic orders from customers.

Conclusion

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method for providing information concerning treatments, comprising:
providing an interface to access a server, the interface accessible by a user, wherein the interface presents the user with a means to select one or more conditions;
receiving a selection of at least one of the one or more conditions via the interface;
querying one or more databases with the selection to obtain a result, wherein the result includes medical information relevant to the selection, wherein the medical information includes at least one of medical conditions, drug information, adverse affects associated with drugs, clinical trials, medical conventions, or prescription refill notifications; and
providing the result to the user via the interface.

2. The method of claim 1, further comprising:
receiving personal information from the user;
storing the personal information in the one or more databases;
obtaining permission from the user to share the personal information;
providing the personal information to a second user in accordance with the permission from the user.

3. The method of claim 1, wherein the interface is presented in a browser window.

4. The method of claim 1, wherein the interface provides for registering a drug, wherein the registering includes providing additional medical information relevant to the drug.

5. The method of claim 4, wherein registering a drug includes receiving medical information relevant to the drug from a pharmaceutical company.

6. The method of claim 5, wherein registering a drug includes at least one of: queuing the received medical information relevant to the drug from the pharmaceutical company;
reviewing the received medical information;
requiring revisions to the received medical information if necessary;
approving the received medical information; or
posting the approved received medical information.

7. The method of claim 1, wherein the selecting includes at least one of:
selecting a request to locate clinical trials, selecting a request to locate drugs by condition,
selecting a request to provide additional medical information, selecting a request to locate medical conventions, selecting a request to locate substance abuse centers, or selecting a request to locate recently added medical information.

8. The method of claim 4, wherein the registering includes logic to perform at least one of validating, queuing, approving, modification, revisions, change control, or staging processes.

9. A system for providing information concerning treatments, comprising:
means for providing an interface to access a server, the interface accessible by a user, wherein the interface presents the user with a means to select one or more conditions;
means for receiving a selection of at least one of the one or more conditions via the interface;
means for querying one or more databases with the selection to obtain a result, wherein the result includes medical information relevant to the selection, wherein the medical information includes at least one of medical conditions, drug information, adverse affects associated with drugs, clinical trials, medical conventions, or prescription refill notifications; and
means for providing the result to the user via the interface.

10. The system of claim 9, further comprising:
means for receiving personal information from the user;
means for storing the personal information in the one or more databases;
means for obtaining permission from the user to share the personal information;
means for providing the personal information to a second user in accordance with the permission from the user.

11. The system of claim 9, wherein the interface is presented in a browser window.

12. The system of claim 9, wherein the interface provides for registering a drug, wherein the means for registering includes means for providing additional medical information relevant to the drug.

13. The system of claim 12, wherein the means for registering a drug includes means for receiving medical information relevant to the drug from a pharmaceutical company.

14. The system of claim 13, wherein the means for registering a drug includes at least one of:
means for queuing the received medical information relevant to the drug from the pharmaceutical company;
means for reviewing the received medical information;
means for requiring revisions to the received medical information if necessary;
means for approving the received medical information; or
means for posting the approved received medical information.

15. The system of claim 9, wherein the means for selecting includes at least one of:
means for selecting a request to locate clinical trials, means for selecting a request to locate drugs by condition, means for selecting a request to provide additional medical information,
means for selecting a request to locate medical conventions, means for selecting a request to locate substance abuse centers, means for requesting a pharmaceutical representative contact one or more physicians about one or more drugs, or means for selecting a request to locate recently added medical information.

16. The system of claim 12, wherein the means for registering includes logic to perform at least one of following: means for validating, means for queuing, means for approving, means for modifying, means for revising, means for controlling changes, or means for staging processes.

17. A computer program product embodied on a computer readable media, the program product adapted to enable a computer to perform a method for providing information concerning treatments, the method comprising:
providing an interface to access a server, the interface accessible by a user, wherein the interface presents the user with a means to select one or more conditions;
receiving a selection of at least one of the one or more conditions via the interface;
querying one or more databases with the selection to obtain a result, wherein the result includes medical information relevant to the selection, wherein the medical information includes at least one of medical conditions, drug information, adverse affects associated with drugs, clinical trials, medical conventions, or prescription refill notifications; and
providing the result to the user via the interface.

18. The method of claim 1, further comprising:
receiving a request from a physician user for at least one of a call or visit from a pharmaceutical representative.

19. The method of claim 1, further comprising:
receiving a search for drugs by at least one of: criterion meeting drugs; condition related drugs; all FDA approved drugs; brand drugs; or generic drugs from the user.

20. The method of claim 1, further comprising:
receiving requests for patient assistant from the user including at least one of: a patient assistance databank, private information, privacy information, government information, pharmaceutical company information, or consumer group information.
